(19) United States
(12) Patent Application Publication
(10) Pub. No.: US 2014/0131139 A1
(43) Pub. Date: May 15, 2014

(54) Lifting Apparatus

(71) Applicants: Steve L. Kitchin, Fort Wayne, IN (US); Kraig J. Schlosser, Columbia City, IN (US)

(72) Inventors: Steve L. Kitchin, Fort Wayne, IN (US); Kraig J. Schlosser, Columbia City, IN (US)

(73) Assignee: Convertastep LLC, Fort Wayne, IN (US)

(21) Appl. No.: 14/078,557

(22) Filed: Nov. 13, 2013

Related U.S. Application Data
(60) Provisional application No. 61/726,059, filed on Nov. 14, 2012.

(51) Int. Cl. B66B 9/08

(52) U.S. Cl. CPC B66B 9/0853
USPC 187/200

(57) ABSTRACT

The invention consists of a lifting apparatus. It is designed to enable a user and their mobility assistance device, such as a wheelchair or power scooter, to enter or exit a facility, i.e. residential or commercial, that has at least one step at the en trance. While the invention is in the “lowered” position. the user can move their MAD atop the platform contained in the present invention. While atop the platform, the user can activate the controls and cause the platform to be moved into the “raised” position. The “raised” position moves the user and their MAD upwards and towards the top step of entrance of the facility. The user can then mobilize their MAD and egress off the platform into the facility. If the user desires to exit the facility, the user then reverses the process and enters onto the platform when it is in the “raised” position. The user, while atop the platform, then lowers the platform to its “lowered” position and is able to egress off of the platform. The present invention accomplishes the “raising” and “lifting” functions while utilizing a minimal footprint and impact on existing groundscape. Additionally, the present invention, by design can be easily relocated if the user desires to do so.

### CROSS-REFERENCE TO RELATED APPLICATIONS

This is a non-provisional utility patent application bearing the title “Lifting Apparatus” filed on Nov. 13, 2013 and claims the benefit of U.S. Provisional Patent Application No. 61/726059 filed on Nov. 14, 2012, the disclosure of which is incorporated, in its entirety, by this reference.

### BACKGROUND OF THE INVENTION

1. Field of the Invention.

The present invention relates to a lifting apparatus that is designed to be utilized by persons who rely upon the assistance of a mobility assistance device (“MAD”), such as a traditional powered or non-powered wheelchair or a battery-powered motor scooter, to traverse over steps that are commonly found at the entrance ways of a residential or commercial facilities. Examples of battery-powered motor scooters that are commonly found in the industry have brand names such as Jazzy® or Hoveround®.

2. Description of the Related Art.

There is already established in the present field of art numerous configurations of devices and traditional-installed ramps that are manufactured from a variety of materials such as wood, concrete, steel, aluminum or combinations of materials thereof. Typically, the existing lifting apparatuses that are found in the market are meant to be permanent installations and are usually found located in the interior of the facility so as to protect the components of the lift from the elements.

In regards to traditional ramps, they are intended to be permanent and to remain in place once installed. Or, if the ramp is removable, it requires great effort to relocate the ramp to an alternate location and leaves an indelible mark on the facility and/or ground space (“groundscape”) where the ramp once existed.

For traditional lifting apparatuses, one huge negative trait is that they tend to be very costly due to the intricacy of their design and installation. Additionally, once installed, they too tend to not be easily removed and relocated without undertaking great expense and effort.

There are also negative traits associated with traditional ramps. First, in regards to residential properties, permanent to semi-permanent ramps are not aesthetically pleasing regardless of the type of materials they are constructed from or the quality of the design and installation. Besides aesthetics, the presence of a ramp can also indicate that at least one of the residents at the location could be a disabled person. The perception of a disability can create a belief that the person is more vulnerable and an easier target for crime.

Yet another drawback to permanent, or semi-permanent, ramps are that due to regulations regarding the design of ramps, namely rise-run and width configuration, they typically require a significant amount of groundscape to create proper slope that meets code. One common method of achieving proper slope is to utilize a series of turns and landings. This ultimately increases the “footprint” that the overall ramp consumes and requires even more groundscape.

Yet another issue with ramps involves the safety of the user. Dependent upon the slope of the ramp, the user may not be able to control the speed they traverse down along the ramp. Additionally, outdoor ramps are exposed to accumulations of ice and/or snow buildup which can make travel upon the ramp difficult and hazardous.

What is needed in the art is a lilting apparatus that is able to lift significant loads, i.e. the combined weight of the user and their MAD, in both the vertical and horizontal direction and that also allows the user to traverse over steps that would have normally been impassible by the user and/or their MAD. Additionally, what is needed is a lifting apparatus that is low-cost, easily installed, easily removed if desired and is aesthetically pleasing. The present invention accomplishes all or these goals.

### SUMMARY OF THE INVENTION

The present invention provides a lifting apparatus that utilizes what is commonly known as a “parallelogram” linkage configuration that is able to be raised or lowered by the user. The invention comprises, in one form thereof, a linkage configuration that is able to lift significant loads in both the vertical and horizontal directions and allows the user to traverse over steps that would have normally been impassible by the user and their MAD.

One advantage of the present invention is that the invention utilizes a very small “foot print.” This means that the present invention utilizes a small base that creates the foundational support for the operation of the present invention. This small base conserves groundscape and still achieves the goals of the lifting apparatus.

Yet another advantage of the present invention is that it is aesthetically pleasing in that the goals of raising or lowering the user and their MAD are achieved without utilizing a great length of ramp with landings to accommodate governmental regulations regarding the same. The present invention easily fits into most residential and commercial design schemes and the construction materials can be adapted to fit and blend into most décor.

Yet still another advantage of the present invention is that the invention is made of durable materials, i.e. steel and/or aluminum. These materials are well known in the industry for their high strength, durability, and relatively low-cost.

Yet still another advantage of the present invention is that the entire unit is portable. The present invention easily be picked up and relocated with no-impact on the groundscape or that leaves indelible marks on the facility or existing groundscape. This allows the user to easily relocate the present invention should they desire to.

### BRIEF DESCRIPTION OF THE DRAWINGS

The above-mentioned and other features and advantages of the present invention, and the manner of attaining them, will become more apparent and the present invention will be better understood by reference to the following description of embodiments of the present invention taken in conjunction with the accompanying drawings, wherein:

FIGS. 1 illustrates a perspective view of the preferred embodiment of the present invention in the “lowered” position; and

FIG. 2 illustrates a perspective view of the preferred embodiment of the present invention in the “raised” position; and

FIG. 3 illustrates a detailed perspective view of the preferred embodiment of the present invention in the “raised” position; and

FIG. 4 illustrates a detailed perspective view of the supporting structure of the present invention in the “raised” position; and

FIG. 5 illustrates a detailed perspective view of the supporting structure of the present invention in the “lowered” position; and

FIG. 6 illustrates a perspective view of an alternative embodiment of the present invention; and

FIG. 7 illustrates a perspective view of an alternative embodiment of the present invention: and

FIG. 8 illustrates a perspective view of an alternative embodiment of the slave linkage.

Corresponding reference characters indicate corresponding parts throughout the several views. The exemplifications set out herein illustrate preferred embodiments of the present invention, and such exemplifications are not to be construed as limiting the scope of the invention in any manner.

### DETAILED DESCRIPTION OF THE PRESENT INVENTION

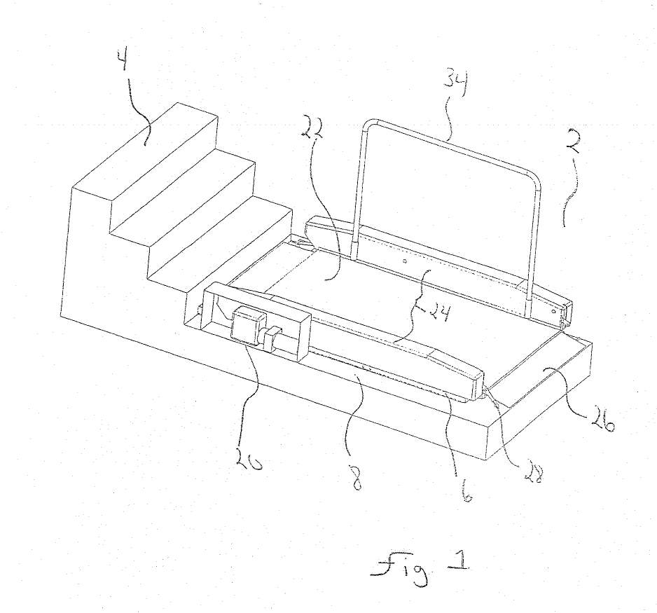

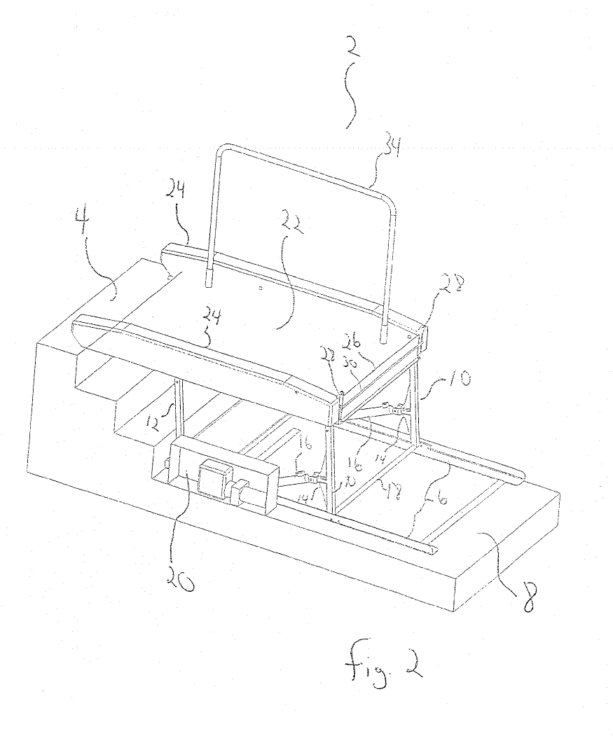

Referring now to the drawings, and, more particularly to FIGS. 1-3, the preferred embodiment of the present invention is a convertastep 2 that comprises two base brackets 6 that provide the foundational base for the structure and operation of convertastep 2.

Still referring to FIGS. 1-3 convertastep 2 is placed adjacent to a step(s) 4 and atop a ground 8. Step(s) 4 can be a single step, or can comprise a plurality of steps, all at various rises and/or run configurations and can even be uneven across the top of steps (4) in the horizontal direction. Attached to each of the base bracket 6 are a master linkage 10 and a slave linkage 12. Master linkages 10 and slave linkages 12 are connected to base brackets 6 and all other mounting points utilized in convertastep 2 by utilizing bearing/bushing attachments that are commonly-known in the industry.

Still referring to FIGS. 1-3, in the preferred embodiment the present invention, there is attached to each of the master linkage 10, a support bracing 14. Support bracing 14 allows a power cylinder 16 to be attached to each master linkage 10. Support bracing 14 distributes the load forces generated by power cylinder 16 along the length of each master linkage 10 and provides overall structural stability and support for convertastep 2. A connecting linkage 18 attaches to each of the master linkages 10 to create a unified linkage such that each master linkage 10 moves simultaneously with each other. Connecting linkage 18 also helps to provide cross-stabilization of convertastep 2 and helps to prevent twisting of base brackets 6 when convertastep 2 is being operated.

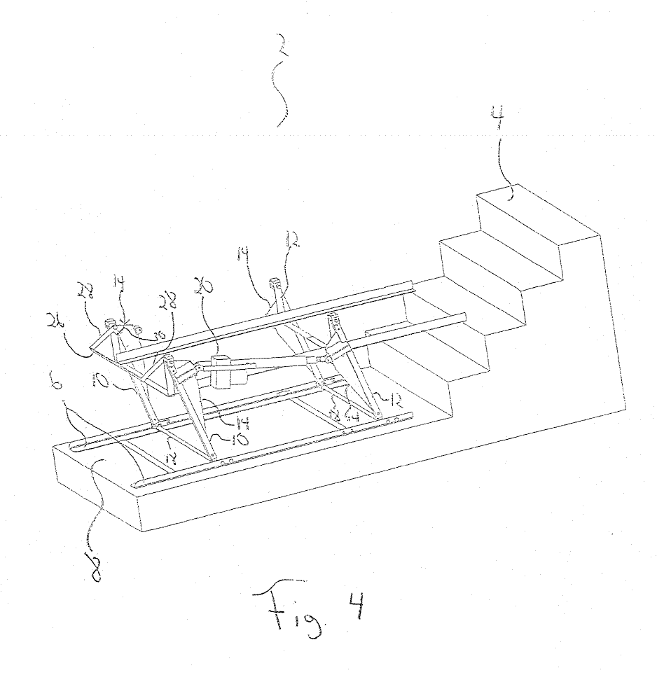

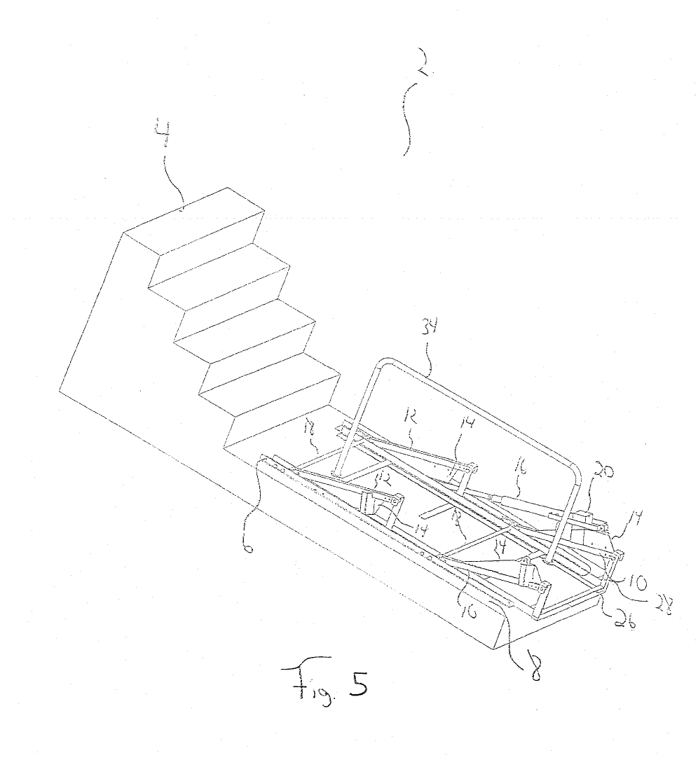

Now additionally referring to FIGS. 4-5, an alternative embodiment of the present invention is shown and attached to each of master linkages 10 and slave linkages 12 is support bracing 14. Support bracing 14 allows power cylinder 16 to be attached to each master linkage 10 and slave linkage 12. Support bracing 14 distributes the load forces generated by power cylinder 16 along the length of each master linkage 10 and slave linkage 12 and provides overall structural stability and support for convertastep 2. A connecting linkage 18 attaches to each of the master linkages 10. Additionally, another connecting linkage 18 attaches to each of the slave linkages 12. The purpose of connecting linkages 18 is to create a unified linkage system such that each master linkage 10 and slave linkage 12 moves simultaneously with each other. Connecting linkages 18 also help to provide cross-stabilization of convertastep 2 and helps to prevent twisting of base brackets 6 when convertastep 2 is being operated.

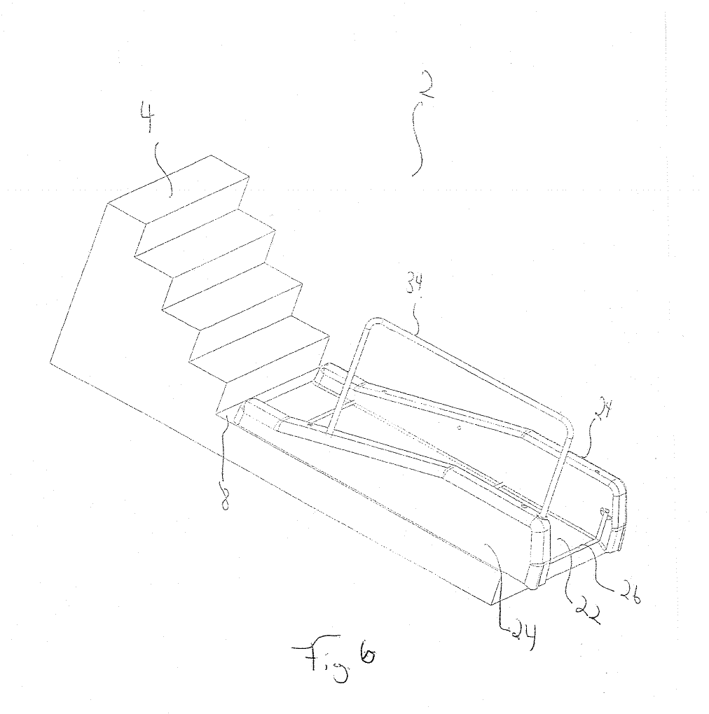

Now referring back to FIGS. 1-5, and additionally referring to FIG. 6, power cylinder 16 is typically that of a hydraulic cylinder that is fed by a hydraulic pump utilizing hydraulic fluid stored in a reservoir. This type of technology is commonly known in the industry. Convertastep 2 relies upon hydraulic cylinders to actuate the movement of convertastep 2, but realistically, power transfer could be achieved from any source such as pneumatic drives, electric actuator drives, and/or worm drives and gears that are turned by electric motors.

Power cylinders 16 receives its power from a power unit 20. Power unit 20 receives commands from the user via a wired and/or wireless control panel or a key fob unit (all not shown.) These control units have simple individual controls contained therein, such as “up”, “down” and/or “stop” commands that direct the movement of convertastep 2.

Master linkages 10 and slave linkages 12 are connected to a platform 22. Platform 22 serves as the deck upon which the user traverses upon either by walking onto it or driving their MAD onto it. Platform 22 can be manufactured from a variety of materials such as traditional wood or simulated wood products, aluminum, steel, or expanded mesh steel. These types of materials are commonly known and found in the industry and are already utilized for ramp surfaces.

Now referring back to FIGS. 1-3, the preferred embodiment of the present invention, power cylinder 20 is affixed to base bracket 6 and to support bracket 14. When force is applied from power cylinder 20 to support bracing 14, the convertastep 2 is either raised or lowered dependent upon the direction of the force being applied.

Now referring back to FIGS. 4-5, in alternative embodiment of the present invention, power unit 20 is affixed between master linkage 10 and slave linkage 12 via support bracing 14. This particular mechanical setup allows convertastep 2 to take advantage of reacting forces to assist the actuation of convertastep 2 and allows platform 22 to be raised with less overall mechanical force.

Still referring back to FIGS. 1-5, in both demonstrated embodiments, master linkages 10, slave linkages 12, and power cylinder 16 are aligned parallel with the sides of platform 22 and are located on the sides of platform 22 so that when platform 22 is in the lowermost position, the “parallelogram” configuration created by master linkage 10 and slave linkage 12 is collapsed to an angle of approximately seven degrees. Additionally, the entirety of the linkage configuration lies adjacent to the sides of platform 22.

This type of linkage configuration allows convertastep 2 to maintain a low profile as possible when convertastep 2 is in the full downward “lowered” position. This not only helps with the appearance of convertastep 2, but also helps to keep shipping costs of convertastep 2 low when it is shipped to the user's location. Also, by having master linkages 10 and slave linkages 12 in an offset position, rather than centered, it allows platform 22 to rise and wing over existing steps and ultimately reach the top step of step(s) 4.

Now referring back to FIG. 6, on each side of platform 22. covering master linkages 10 and slave linkages 12, is a cover 24. Cover 24 helps to keep “pinch points” properly covered and also prevents environmental elements from reaching the bearings/bushings used in convertastep 2. Cover 24 also keeps power cylinder 16 and its related hoses from being exposed to environmental elements.

Now referring back to FIGS. 4-5, located at the end of platform 22 furthest away from step(s) 4 is a safety bar 26. Safety bar 26 moves upwardly or downwardly depending upon the actuation direction of platform 22. When platform 22 is being lowered, safety bar 26 is simultaneously lowered. Safety bar 26 is able to simultaneously move with the actuation of convertastep 2 due to the incorporation of a safety bar arms 28 an a safety bar connecting linkage 30. Safety bar arms 28 are attached to master linkages 10 and to safety bar connecting linkage 30.

In an alternative embodiment of the present invention, safety bar 26 can be that small, inclined ramp. This ramp allows the user to easily make the transition from ground 8 to the top of platform 22. When platform 22 is raised, safety bar 26 is also raised and thus prevents a MAD located atop platform 22 from rolling off platform 22.

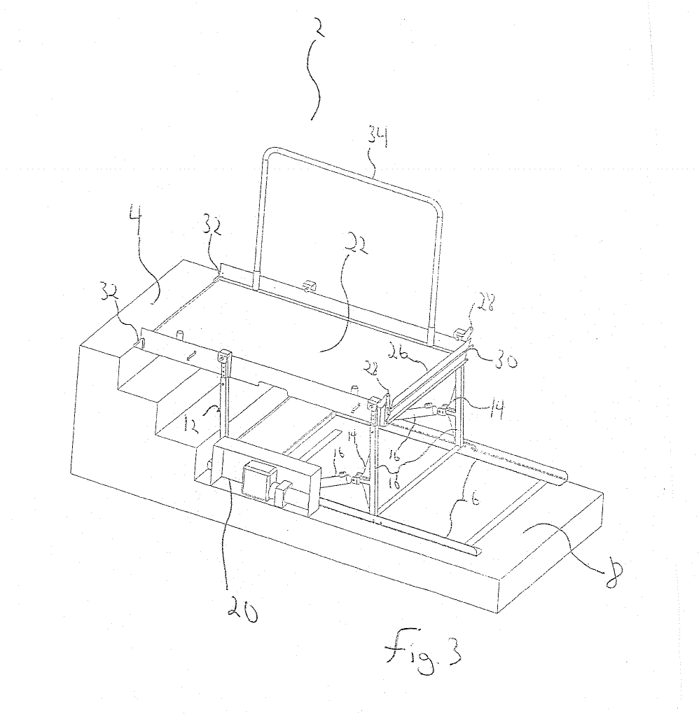

Now referring back to FIG. 3, on the step(s) 4 end of platform 22, there is located a plurality of support tabs 32. Support tabs 32 are attached to platform 22 and provide several benefits. First, support tabs 32 are adjustable to accommodate step(s) 4 that may be uneven in the horizontal direction. Second, support tabs 32, once adjusted, allow platform 22 to be stable once placed upon the top step of step(s) 4. This allows the user to easily transition from platform 22 to the top of step(s) 4.

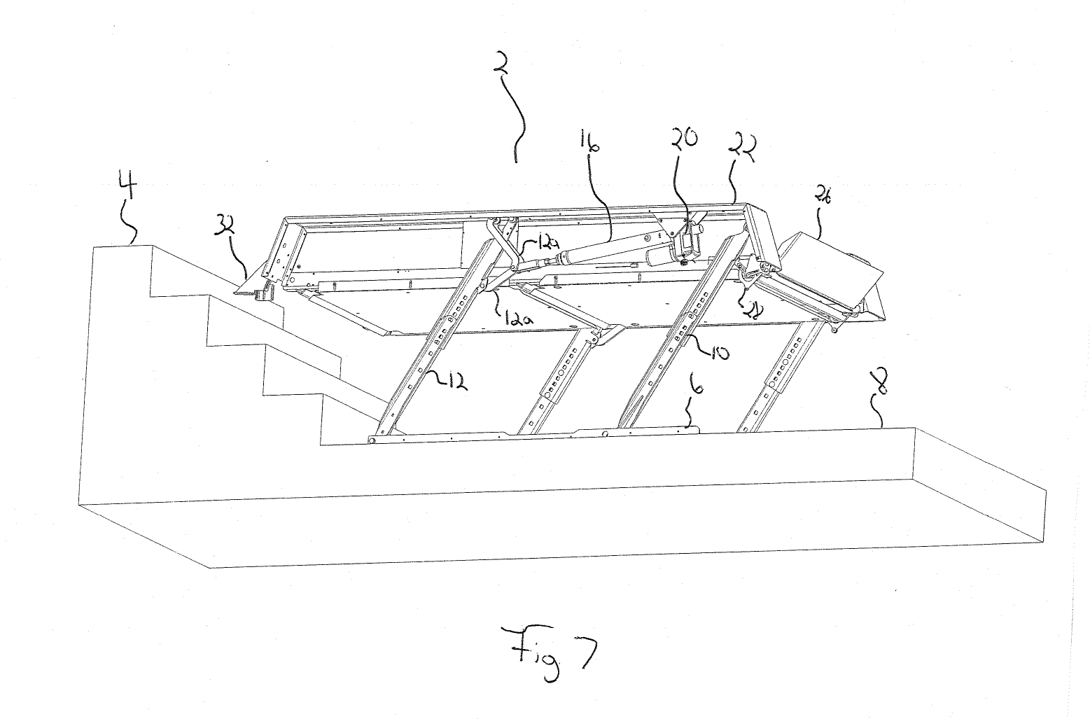

Now additionally referring to FIG. 7, another alternative embodiment of the present invention is demonstrated. In this alternative embodiment of the present invention, additional linkages, namely a slave support linkage 12a and a slave support linkage 12b are affixed to slave linkage 12 and platform 22 for purposes of creating a “six bar” linkage system to transfer force to slave linkage 12 from power cylinder 16 that is affixed to platform 22. Master linkage 10 in essence then becomes an “idler” linkage and is used to support the load atop platform 22 and to control the movement of platform 22 while moving from a “raised” and “lowered” position.

There are a plurality of benefits achieved from this particular type or linkage configuration. First, this particular linkage configuration lessons the initial force necessary to begin moving platform 22 from the first position to the second position. Higher forces can be realized when utilizing a convertastep 2 that is setup to rise up to a large number of steps and thus requiring a bigger “swing” are to reach the top of the steps4. This particular linkage configuration also allows convertastep 2 to operate faster while moving from the “raised” and “lowered” positions. The power cylinder 16 also requires less electrical load to create the power transfer necessary for convertastep 2 to function.

Yet another additional benefit of this type of linkage configuration is that plurality of supporting linkages and the power cylinder is safely covered by cover 24. This helps to provide additional coverage from the elements and helps to eliminate any pinch points may be presented in convertastep 2.

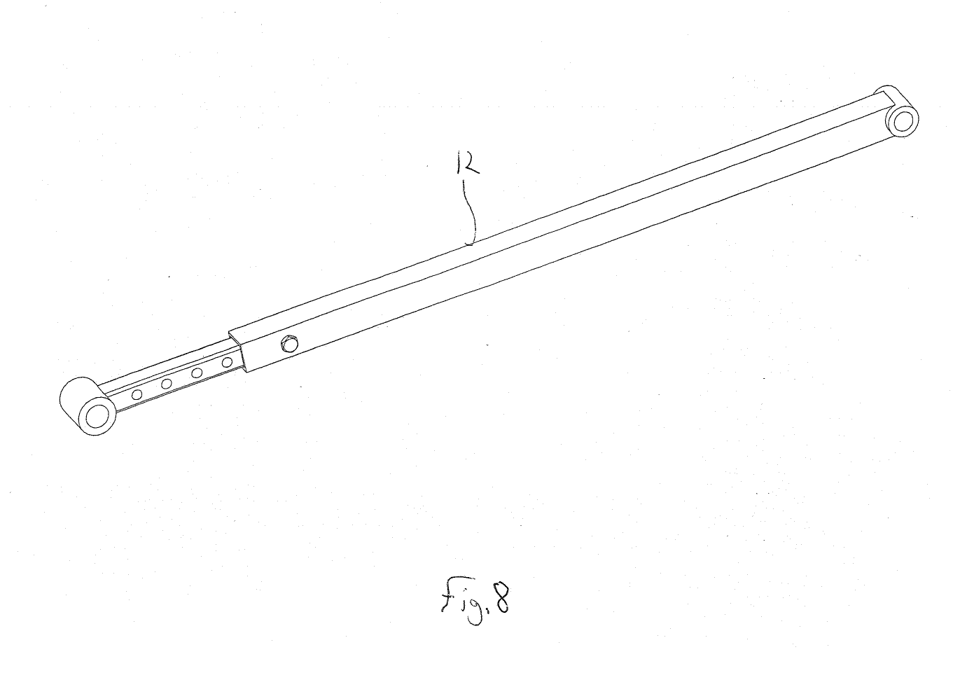

Now additionally referring to FIG. 8. another feature of master linkages 10 and slave linkages 12 is that they are adjustable. Adjustability of master linkages 10 and slave linkages 12 controls the overall height of platform 22. In an alternative embodiment of the present invention, each linkage consists of an outer and inner tube containing a plurality of holes. These holes allow the insertion of a bolt or pin to secure the linkage to the final desired height. In yet another alternative embodiment of the present invention. master linkages 10 and slave linkages 12 consists of a single tube with a plurality of adjustment holes located on one end. Ultimately, these adjustability features allow convertastep 2 to accommodate varying heights of step(s) 4 and increases the overall versatility of the present invention.

Now referring back to FIGS. 1-6, yet another other alternative embodiment of the present invention can include the installation of an assistance bar 34. Assistance bar 34 adds extra safety and comfort for the user when convertastep 2 is being cycled because it is a place for the user to grab on to help them stabilize their body. Yet still another alternative embodiment of the present invention can include the installation of a folding chair (not pictured) or bench (not pictured) located on one side of platform 22. This would allow the user to sit while convertastep 22 is being cycled. Yet more alternative embodiments of the present invention can include wheels installed on base brackets 6 to make convertastep 2 more easily transported between facilities or even wheeled out of the way when not in use. Still another alternative embodiment of the present invention utilizes the addition of a solar panel to provide electrical power for operation of convertastep 2 makes it more usable in areas with limited electrical service.

While this invention has been described with respect to preferred embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains, and to which the claims are directed. It is therefore intended that the present invention be not limited to the exact forms described and illustrated herein, but should be construed to cover all modifications that may fall within the scope of the appended claims.

What is claimed:

1. A lifting apparatus comprising: a base bracket and a plurality of supporting linkages connected to a platform that departs from the base bracket; and means for moving the platform from a first position with the platform nearest and parallel to a ground surface with a hinged ramp, mounted at one end of the platform farthest from the entrance of the facility, deployed so that a user and a mobility assistance device may traverse atop the platform and the hinged ramp is undeployed, a second position wherein the platform is raised parallel with the ground surface upwards and towards planarly and parallel with the entrance of a facility wherein the platform rests upon atop a step wherein the user and their mobility assistance device exits from the platform interior to the facility.

2. The lilting apparatus of claim 1 and further including an at least one assistance bar affixed perpendicularly to and atop the platform for purposes of providing the user with a handhold.

3. The lifting apparatus of claim 1 and further including an at least one cover enclosing the supporting linkages and the means for moving the platform, from environmental influences and other interferences that may affect the operation of the lifting apparatus of claim 1.

4. The lilting apparatus of claim 1 and further including an at least one supporting tab affixed to the platform end opposite the hinged ramp end to rest upon the step when the platform is raised to the second position.

5. A lifting apparatus comprising:
a base bracket;
a plurality of supporting linkages;
a power system; and
a platform having a first end, second end, underside and topside.

6. The lifting apparatus according to claim 5, wherein the plurality or supporting linkages further comprises an at least one master linkage, an at least one slave linkage, and an at least one support bracing.

7. The lifting apparatus of claim 6, wherein the at least one master linkage has a first end connected to the base bracket and a second end connected to the second end of the platform.

8. The lilting apparatus of claim 7, wherein the at least one master linkage is variable in length between the first end of the at least one master linkage and the second end of the at least one master linkage.

9. The lifting apparatus of claim 6, wherein the at least one slave linkage has a first end connected to the base bracket and a second end connected to the first end of the platform.

10. The lifting apparatus of claim 9, wherein the at least one slave linkage is variable in length between the first end of the at least one master linkage and the second end of the at least one master linkage.

11. The lifting apparatus of claim 7, wherein the first end of the at least one master linkage is connected to a first end of an at least one connecting linkage and the first end or a second at least one master linkage is connected to the second end of an at least one connecting linkage.

12. The lifting apparatus of claim 9, wherein the first end of the at least one slave linkage is connected to a first end of a second at least one connecting linkage and the first end of a second at least one slave linkage is connected to the second end of the second at least one connecting linkage.

13. The lifting apparatus of claim 7, wherein the at least one master linkage has affixed along the longitudinal axis of, and perpendicular to, the at least one master linkage, a supporting bracket.

14. The lifting apparatus of claim 5, wherein the power system further comprises a hydraulic cylinder having a first end and a second end with the first end of the hydraulic cylinder affixed to the base bracket and the second end of the hydraulic cylinder affixed to the supporting bracket.

15. The lifting apparatus of claim 5, wherein on the second end of the platform is attached a safety gate having a pivot end and a non-pivot end.

16. The lifting apparatus or claim 15, wherein the pivot end of the safety gate is affixed to the second end of the platform and enables the safety gate to swing about a rotational axis arranged perpendicularly to the longitudinal axis of the platform and located on the topside of the platform.

17. The lifting apparatus of claim 15, wherein the non-pivot end of the safety gate has mounted at least one safety gate arm having a first end connected to the second end of the at least one master linkage and a second end connected to the non-pivot end of the safety gate.

18. A wheelchair lift comprising:
a base;
plurality of supporting linkages;
platform; and
a means for raising or lowering the platform via the supporting linkages.

19. The wheelchair lift of claim 18, wherein the plurality of supporting linkages is mechanically affixed to the base.

20. The wheelchair lift of claim 18, wherein the platform is mechanically affixed to the plurality of supporting linkages.
